(19) United States
(12) Patent Application Publication
(10) Pub. No.: US 2013/0104105 A1
(43) Pub. Date: Apr. 25, 2013

(54) TEST DATA SUPPLY CHAIN MANAGER FOR AN INTEGRATED TESTING PLATFORM

(71) Applicants: Julian M. Brown, London (GB); Peter J. Smith, London (GB); Stephen M. Williams, Warrington (GB); Jason A. Steele, London (GB)

(72) Inventors: Julian M. Brown, London (GB); Peter J. Smith, London (GB); Stephen M. Williams, Warrington (GB); Jason A. Steele, London (GB)

(21) Appl. No.: 13/446,298

(22) Filed: Apr. 13, 2012

Related U.S. Application Data
(60) Provisional application No. 61/476,489, filed on Apr. 18, 2011.

(51) Int. Cl. G06F 11/36

(52) U.S. Cl. CPC G06F 11/3684; G06F 11/3664
USPC 717/124

(57) ABSTRACT

A method of supplying test data for test scripts is provided in an integrated testing platform, where the testing platform includes a prioritization and assignment manager configured forward test scripts to a selected testing individual. Each test script is mapped to an input data set if a corresponding input data set is available. Requests for test scripts made to the prioritization and assignment manager are monitored, and if the test script to be supplied in response to the request has a corresponding mapped input data set, the corresponding input data set is retrieved from a database, and the input data set is provided to the test script prior to execution of the test script.

### CLAIM OF PRIORITY

This application claims the benefit of U.S. Provisional Patent Application Ser. No. 61/476,489 filed Apr. 18, 2011, which is incorporated by reference in its entirety herein.

### BACKGROUND OF THE INVENTION

1. Technical Field

This disclosure relates to software testing, and in particular, this disclosure relates to an integrated platform for developing, debugging, and executing tests to insure the integrity and functionality of software systems.

2. Background

The development of computer software involves a rigorous testing process to insure that the software functions as intended. During the testing process, testers write various test scripts for performing different types of tests necessary to ensure that the computer software is functioning as designed. The testers also set up and run the test scripts while tracking the results, and report the test result to appropriate personnel. This process is inefficient and time consuming, and requires significant tester involvement.

Further, as businesses continue to rely on computer software and complex software packages, an increasing number of highly complex computer software has been developed to meet business demands. Due to the increased complexity and scale, such software programs require a large-scale testing process involving far more testers and test scripts than were required previously. Such increases are related to organizations centralizing their testing and moving to an outsourced testing model. Traditionally testing was ‘embedded’ into the systems development life cycle (SDLC) for each project, but now central ‘discrete’ testing functions exist within organizations, which test across multiple projects and releases.

Testing tools have been developed to assist the testers in performing the various steps of the testing process. However, existing testing tools are not able to provide the required functionality and efficiency to overcome the challenges posed by the large-scale testing process.

Testing of various products and/or software products has increased in complexity and scope. In the past, relatively small groups of designers and developers, perhaps 10 to 30 in number, developed various tests for testing and verifying the function of software modules or code segments. Such small groups of individuals have been manageable. However, as the number of individuals contributing to the project becomes large, redundancy and complexity increase, which contributes to increased cost and an increase in the number of errors. Therefore, a need exists to address the problems noted above.

### SUMMARY

The next generation testing system (NGT) provides a managed service platform for centralized development, debugging, and implementation of software testing, where hundreds to perhaps thousands of individuals can collaborate in developing and implementing a very large array of modules or test scripts that form a suite of tests. The next generation testing system is not limited only to testing of software modules, and may be used for the testing of hardware as well, provided that test result signals and indicators that reflect the state of the hardware are provided to the testing system.

For example, the next generation testing system may be used by an organization or software development house to test and verify the function and operation of a large software package or application, or set of applications such as an accounting system, an invoicing system, an operating system version release, or any other system. The next generation testing system may be used in a test “factory” where many hundreds of individuals perform final tests or quality control tests on the same or similar products, for example, a PC operating system testing prior to release.

The next generation testing system may be used to develop and debug the tests, and may also be used to implement the final testing procedures to verify the release or final quality control of an actual product undergoing testing prior to shipping. The next generation testing system may be used to a) plan and develop the testing of a product for release, b) plan and estimate the effort or manpower required to develop the testing process, c) manage the preparation process, d) manage the distribution of the test scripts to the testing personnel, and e) automate the test process.

A method of supplying test data for test scripts is provided in an integrated testing platform, where the testing platform is configured to organize, manage, and facilitate the debugging of test scripts prepared by a testing individual. The method includes a test data supply chain configured to map an input data set to each test script if a corresponding input data set is available. Requests for test scripts made to a prioritization and assignment manager are monitored, and if the test script to be supplied in response to the request has a corresponding mapped input data set, the corresponding input data set is retrieved from a database, and the input data set is provided to the test script prior to execution of the test script.

Other embodiments of systems, methods, features, and their corresponding advantages will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The system may be better understood with reference to the following drawings and the description. The components in the figures are not necessarily to scale, emphasis instead being placed upon illustrating the principles of the invention. Moreover, in the figures, like-referenced numerals designate corresponding parts throughout the different views.

FIG. 1 is a high-level block diagram showing a specific embodiment of the primary components of a next generation testing system;

FIG. 2 is a diagram of an overall testing process using the next generation testing system;

FIG. 3 is a logical diagram of a user interface of a specific embodiment of the modular script designer;

FIG. 4 is a screenshot of an embodiment of the modular script designer;

FIG. 5 is a screenshot of an embodiment of a modular script designer;

FIG. 6 is a high-level block diagram showing a machine environment in which the next generation testing system may operate;

FIG. 7 is a high-level block diagram of a computer system;

FIG. 8 is a logical diagram of an embodiment of the NGT system;

FIG. 9 is a logical diagram of an embodiment of the NGT system;

FIG. 10 is a high-level hardware block diagram of another embodiment of the NGT system.

### DETAILED DESCRIPTION OF THE PREFERRED EMBODIMENTS

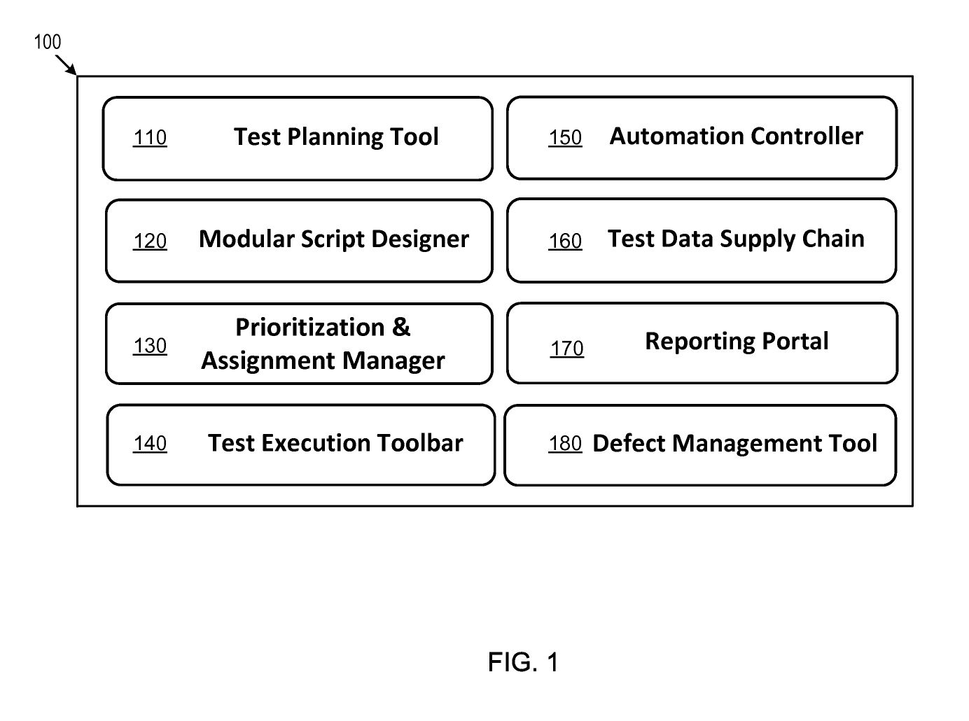

FIG. 1 is a high-level block diagram showing eight components of a next generation testing system 100, which includes a test planning tool 110, a modular script designer 120, a prioritization and assignment manager (PAM) 130, a test execution toolbar 140, an automation controller 150, a test data supply chain controller 160, a reporting portal 170, and the defect management tool 180.

The next generation testing system 100 may be a suite of tools that are integrated with existing or underlying basic test tools. Thus, the next generation testing system 100 does not necessarily replace existing management and development tools, but rather augments and extends the capability of such existing tools. The next generation testing system 100 acts as a layer on top of existing management and development tools.

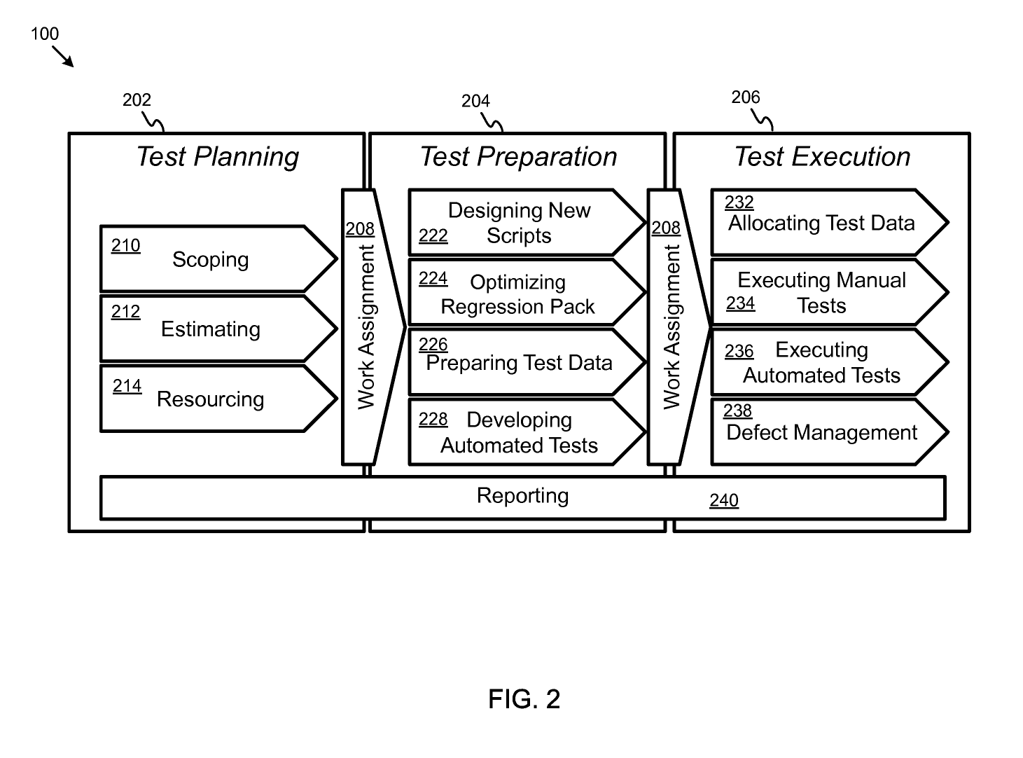

FIG. 2 is a diagram of an overall testing process using the next generation testing system 100. The testing process may include a test planning stage 202, a test preparation stage 204, and a test execution stage 206. Transitioning from the test planning stage 202 to the test preparation stage 204, and from the test preparation stage 204 to the test execution state 206 may involve work assignment 208. The test planning stage 202 may include scoping 210, estimating 212 and resourcing 214. The test preparation stage 204 may include designing new scripts 222, optimizing regression pack 224, preparing test data 226, developing and developing automated tests 228. The test execution stage 206 may include allocating test data 232, executing manual tests 234, executing automated tests 236, and defect management 238. The next generation testing system 100 may also include reporting capability 240 throughout all stages of the testing process. The next generation testing system 100 may provide increased efficiency and functionality across all stages of testing.

Turning back to FIG. 1, the test planning tool 110 estimates and plans the preparation, work and manpower requirements involved in the start of a particular software release. The test planning tool 110 provides an indication of the plurality of skill sets required to test the various test scripts, and the different skill groups associated with the testing personnel available. The test planning tool 110 also provides assisted estimation. The test planning tool may use a three stage process to provide estimation at increasing levels of accuracy. Information is used from previous releases to improve estimates. Pluggable architecture for client-specific calculations may be used. The test planning tool 110 also provides deconstruction of requirements into tests.

The test planning tool 110 assists the user in breaking down requirements into a required number of tests. Collaborative working capabilities allow a divide and conquer approach. The test planning tool 110 further provides resource forecasting by skill. The test planning tool 110 may allow early foresight of skills required to support the testing activities and present a graphical display of availability versus demand. The test planning tool 110 further helps to shape the test organization by promoting cross-skilling. The test planning tool 110 also provides regression pack suggestions. Using a meta-data driven approach, the system suggests an appropriate regression pack. Risk-based testing scores can be used to size the pack accordingly. The test planning tool 110 essentially quantifies what items need to be tested, what skill sets are required to perform the tests, and whether the required skill sets are present in the resources provided.

The modular script designer 120 is used to design new tests or test scripts in a modular way, and increases the efficiency of the testing effort and the organization by maximizing the benefit of test scripts that have been written by other designers, engineers, or testing individuals. This avoids redundancy by reusing test scripts that others have created, and which have been functionally verified. The modular script designer 120 also provides for re-use of modules rather than complete scripts, as a test script is composed of several test modules, and where each module represents a logical part of a test, for example, a login to an application.

The modular script designer 120 coordinates the creation and existence of newly created test scripts with all of the testing personnel associated with the next generation testing system 100, and verifies that the test script is suitable for its testing purpose. This reduces the chance that one of the testing individuals creates a redundant test script, and also provides an indication to the test individual at the test script at issue is suitable for his or her purpose in the target system.

Each test script created by a testing individual or test creator using the modular script designer 120 includes associated data corresponding to approval history of the test script and the functional location or hierarchy of the test script with respect to other test scripts that are executed before and after the test script at issue. The associated data for a test script also includes a description of the function of the test script and a description identifying the products for which the test script is used.

Once a test script has been designed using the modular script designer 120, it is saved and eventually uploaded to the standard test tool, which may be a separate and independent commercially available testing device or system used by the next generation testing system 100. As mentioned above, the next generation testing system 100 does not replace the low-level or basic testing tool. For example, the basic testing tool may be a Hewlett Packard HP Quality Center™ testing tool, IBM Rational Quality Manager, or other commercially available basic testing tool, which may run under the control and direction of the next generation testing system 100. The next-generation testing system 100 is integrated with all of the various basic testing tools and allows communication to and from the various basic testing tools.

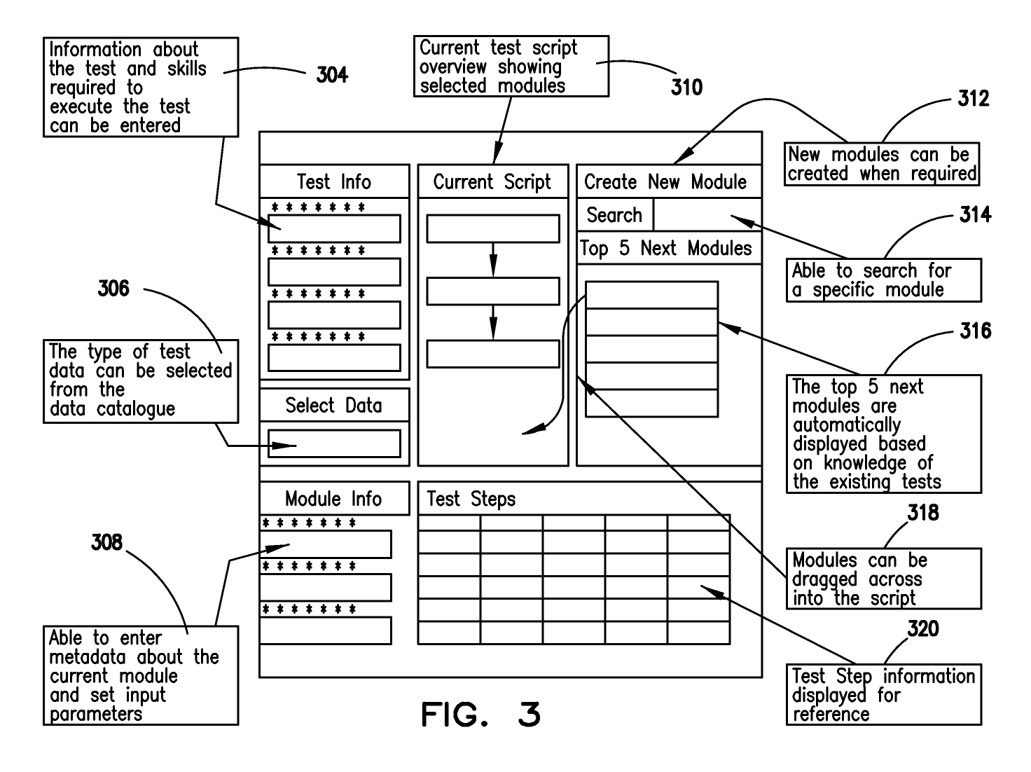

FIG. 3 is a logical diagram of a user interface of a specific embodiment of the MSD 120. The MSD 120 may allow the tester to quickly design new scripts based on an existing repository of modules. Where a new module is required, the tester may create that module within the MSD 120. Using the MSD 120, the tester may enter information about the test and skills required to execute the test 304. The tester may select the type of test data from a data catalogue 306. The tester is also able to enter metadata about the current module and set input parameters for the module 308. MSD 120 may also show an overview of the current test script. The overview may show the modules selected for the current test script 310. New modules can be created when required 312 using the MSD 120, and the tester is able to search for a specific module 314. The MSD 120 may automatically also show the top five next modules, which the tester is likely to use next 316. Any other number possible next modules may be displayed. The likely next modules are determined based on knowledge of the existing tests. The MSD 120 may allow a tester to drag and drop modules into the script 318. The MSD 120 may also display test step information for a testers' reference 320.

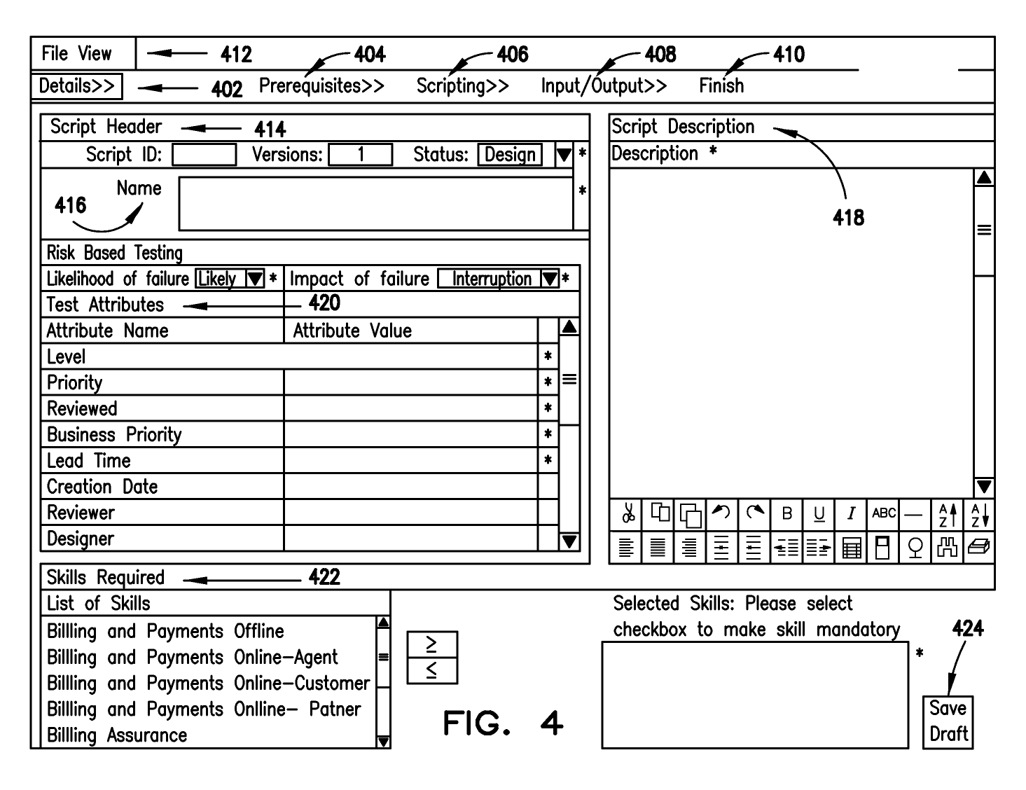

FIG. 4 shows a screen shot 400 of an embodiment of the MSD 120. The user interface may include a plurality of screens, or tabs, including a Details tab 402, a Prerequisites tab 404, a Scripting tab 406 shown in more detail in FIG. 4, an Input/Output tab 408, and a Finish tab 410. The plurality of screens, or tabs, may guide the user through the script design process by displaying options and information to user and prompting the user to input information to create or design a script. For example, the user may begin on the Details tab 402 by clicking a File button to access and choose from a drop down list of functions, including Open Script, New Script, View Script, Clone Script or Saved Drafts. The tester may also input, on the Details tab 402, key information about the script. The key information may include script header 414, a script name 416, a description of the script 418, names and values of test attributes 420, skills required to complete script execution 422, and a requirement reference for the script. The user may select required skills 422 from a list of skills displayed on the Design tab 402. The required skills 422 may later be used to assign the scripts to relevant, or qualified, testers and approvers. The Details tab 402 may further include a Save Draft button 424, which the user may click to save the script information entered. On the Prerequisites tab 404, the MSD 120 may display and allow the user to modify prerequisites for executing the script, which may include data type, data comments and other prerequisites. Other embodiments may include fewer, additional or alternative screens, or tabs, to display script options and information to the user, and to accept user input regarding scripts.

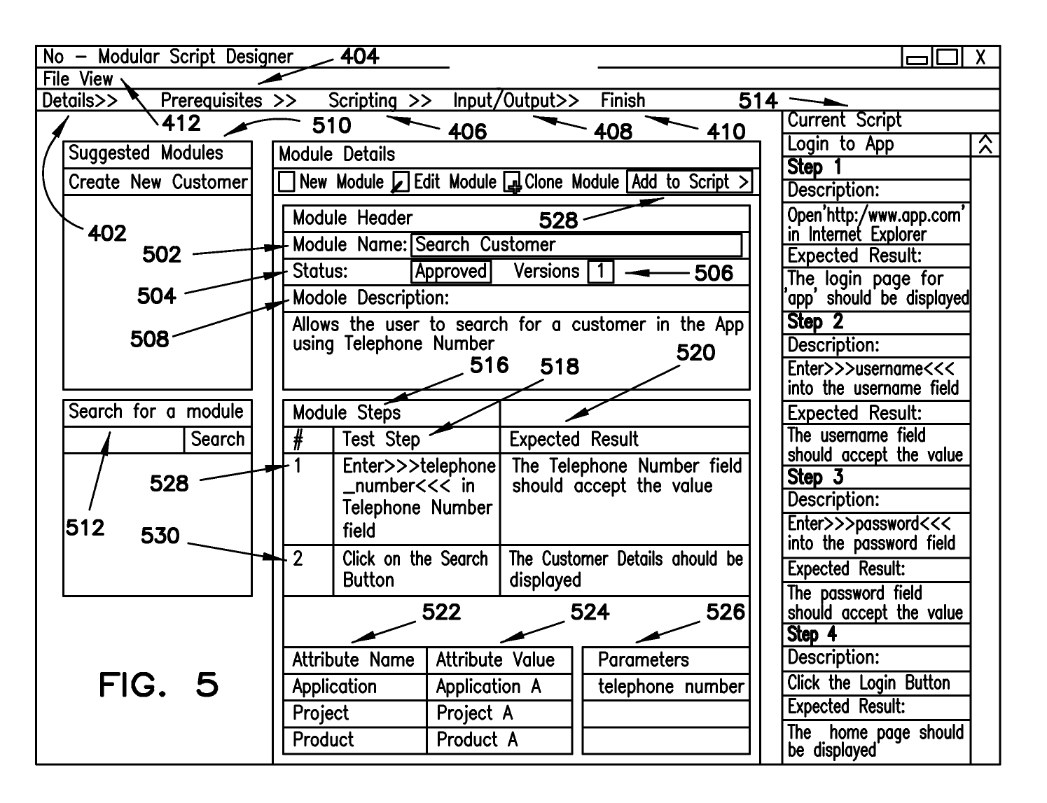

As shown in FIG. 5, the Scripting tab 406 may display to the user all modules that are in the test script, and allow the user to add a module to the script by creating a new module, editing an existing module, or cloning an existing module. The user may also input data regarding a module, including, for example, a module name 502, a status of the module 504, a version of the module 506, and a module description 508. The user interface may further display to the user a plurality of options in panes, including suggested modules 510 to include in the script and the option to search for modules 512.

The user may select a module from the suggested modules 510 by clicking and dragging a module of choice into a Current Script field 514. The user may input additional information regarding the module, including components to which the module is linked (pulled from a configuration management database (CMDB) and any other metadata). The user interface may display to the user other information regarding the script, including for example, module steps 516, test steps for each module step 518, expected results for each module step 520, current script steps 514, attribute names 522, attribute values 524, and parameters 526. The user may click the “Add to Script” button 528 to add a module to the script.

The prioritization and assignment manager 130 is an important element of the next generation testing system 100. The prioritization and assignment manager 130 tracks all of the tests or test scripts in the suite of tests as part of a list in a database and assigns a priority to each of the individual test scripts based on a given set of prioritization factors and assignment factors.

Prioritization factors may be script attributes, including, for example, impact of failure, likelihood of failure, lead time, business priority, estimated effort, and test end date. The prioritization and assignment manager 130 may use prioritization factors to assign a numeric rating to a script for stack ranking, e.g., to evaluate a priority for execution of the script.

Assignment factors may be user attributes evaluated to weight a user against a set of scripts that are available for testing, and may be a numerical value assigned to a script for an individual user. Assignment factors may include, for example, skills required, skills of a tester, status of a script, script workstream, tester workstream, script author, a user's previous experience with a script or its predecessor, and information regarding the tester to whom the script is assigned. The prioritization and assignment manager 130 may use assignment factors to assign a numeric value to a script for an individual user. The priority of a particular test script determines its position in the testing queue. The prioritization and assignment manager 130 may use the prioritization factors and assignment factors together to match and assign a script to a user at the time of a request.

The prioritization and assignment manager 130 provides a centralized automated prioritization of test scripts with real-time assignment logic. All test scripts are prioritized based on a centralized set of factors, which can be configured centrally to influence the entire test operation (for example, to improve performance against KPIs (Key Process Indicators)). The prioritization and assignment manager 130 further provides a skill based assignment, and provides a pull, rather than a push, approach. Testers may click a ‘Get Next’ icon on their desktop screen to be assigned the next script to execute. The next script is chosen in real-time based on weighted assignment factors

Each of the factors used to assign priority to the test script may be weighted. In one example, a developer may be presented with a screen having a plurality of sliders or buttons corresponding to each test script. Moving the slider to the right may increase the priority level associated with the corresponding test script, while a moving the slider to the left may decrease the priority level associated with the corresponding test script. Thus, the tester may assign a priority level to a test script based on the tester's judgment and expertise. The prioritization of the various test scripts may affect the relationship and interaction between all of the various test scripts. The prioritization and assignment manager 130 may perform the prioritization function in a batch mode after receiving input from the test script creator.

Some of the factors associated with the assigned priority of the test scripts may have feedback or decision tree capability so that, for example, if a test is performed and returns a failure indication, the prioritization and assignment manager 130 can identify the other test scripts which may be impacted by the failure.

The prioritization and assignment manager 130 also assigns a set of skills to each of the test scripts in the next generation testing system 100 to optimize use of the work force personnel. For example, various test scripts are assigned to testing personnel based on the skill set of the particular testing individual.

For example, a tester may click a Get Next button or icon on a screen to request that a new test script be sent to that tester. The prioritization and assignment manager 130 may access a database containing the skill sets of each tester, and assign the next highest priority test script to that tester based on the tester's skill set and the skill set required by the test script, so as to optimize the productivity of the system and the testing personnel overall. Once the tester receives the test script, he or she will run the test script.

The prioritization and assignment manager 130 may also provide a pluggable framework for new factors. New decision factors can be added by defining a new factor class. The factor may be presented through the user interface and can be weighted in the decision logic. This could be used to enable advanced ‘Applied Statistic’ decision models.

The test execution toolbar 140 is a toolbar visible on the tester's computer screen, and provides an indication of every major tool available to the tester, and every major test that the tester may or must invoke. It is conveniently displayed to the tester to increase efficiency. The test execution toolbar 140 may provide in-line test execution. The test execution toolbar 140 allows a tester to load a test, execute the test and record the status from the toolbar.

Test scripts can be opened directly within the toolbar, which saves room on a tester's desktop and avoids certain keystrokes, such as ALT-Tabbing, between screens. Defect raising and screen capture may be part of the process. The text execution tool bar 140 may also provide an embedded approvals lists. All module/script approvals may be shown in the toolbar, and an approver can quickly open the relevant script/module for approval. The test execution toolbar 140 also allows quick access to all NGT tools. A quick launch bar may be provided to enable the tester to quickly access all of the NGT tools. The toolbar may also handle login management for NGT. A user profile section is available to change user information. The test execution toolbar 140 is also dockable with an auto-hide function. The test execution toolbar 140 may be docked to the left hand side of the screen, and it can be selected to be visible or auto-hide. An extendable framework allows additional panels to be added to the toolbar. The test execution toolbar 140 may be integrated with the prioritization and assignment manager 130 to allow a tester to request the next test that should be run.

The automation controller 150 is an application that may run on a virtual machine, such as in a server farm, or a computing machine in a “cloud” environment. The automation controller 150 may communicate with the prioritization and assignment manager 130 to request the next test script in the testing queue, and facilitate opening of the test script using the basic testing tool described above, such as HP Quick Test Pro.

The automation controller 150 may execute the test script using the basic testing tool, and record the results back into the basic testing tool. The next test script is then requested and the process is repeated. The automation controller 150 further provides modular design and partial automation. Automation scripts may be developed as modules, and each automation module may have one or more manual modules mapped against it. Partial automation enables rapid execution of automated parts of scripts. Essentially, the automation control 150 is used where applicable to automate the execution of test scripts.

An additional feature of the automation controller 150 seeks to maximize the “return on investment” or “ROI” associated with each test script that is run automatically. The automation controller 150 selects for automation the test scripts that provide the greatest ROI collectively. The choice whether to automate a particular test script using the automation controller 150 may be based on the ROI associated with the test script. For example, a particular test script may be a test script that handles initial login by a user. Because a test script that handles initial login by user may be used by hundreds of different test scripts without variation, this testing script provides a high ROI, and as such, may be a good candidate for automation. The ROI essentially is a measure of increased efficiency attained by automation of the test script.

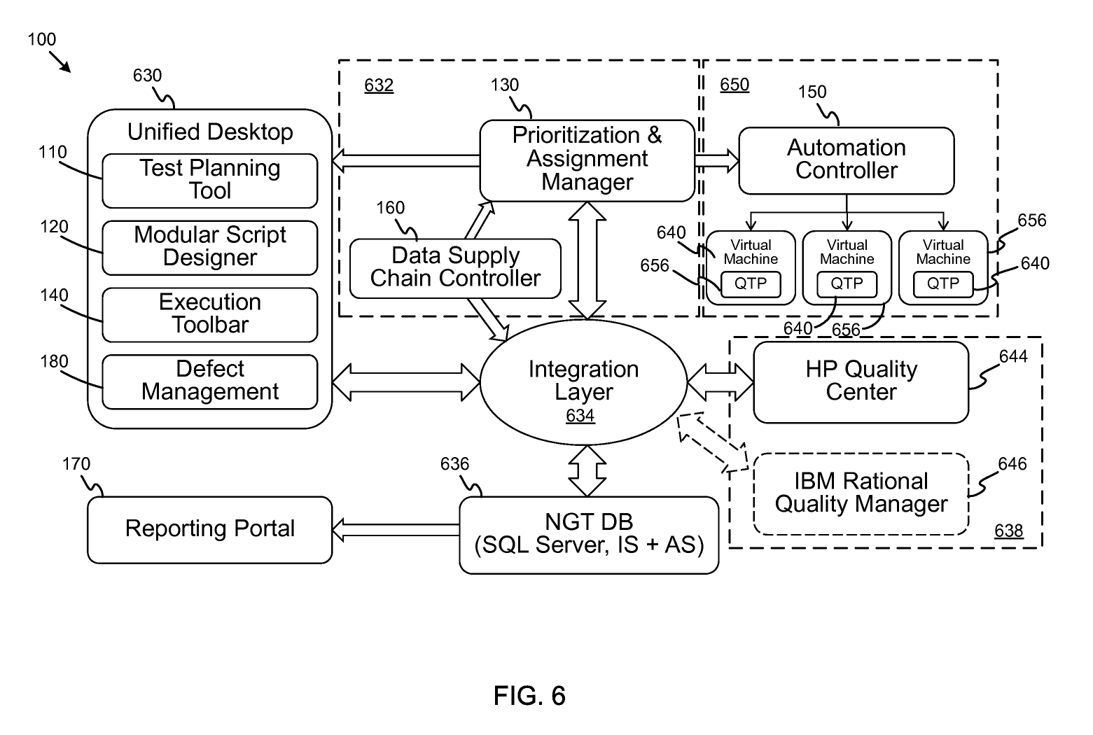

FIG. 6 is a high-level block diagram showing the machine environment in which the next generation testing system 100 may run, and the interconnection between the various hardware and software components. Each testing individual may have a dedicated PC or other computer, referred to as the unified desktop 630. The unified desktop 630 contains various modules of the next generation testing system 100, such as the test planning tool 110, the modular script designer 120 the execution toolbar 140 and the defect management tool 180, running as a “.Net” client.

The prioritization and assignment manager 130, test data supply chain 160 and its associated controller may reside on a server 632 or central server, along with a workflow system configured to schedule and handle execution of various tasks. However, multiple servers may also be used. The workflow system may be provided by Microsoft Windows Workflow Foundation, which also may execute on one or more of the servers.

An integration layer 634 provides communication and functionality between the unified desktop 630, a database 636, the prioritization and assignment manager 130, and the test data supply chain 160. The database 636 stores all of the test scripts and other required data. The integration layer 634 may be a “dll” file resident on the servers 632 and on the client machine, such as the unified desktop 630, and functions as a common API interface. The integration layer 634 is decoupled from the downstream basic testing tools 638, such as an HP Quality Center tool 644 or an IBM Rational Quality Manager 646 by virtue of a pluggable architecture.

The prioritization and assignment manager 130 and the test data supply chain 160 and its associated controller execute under the workflow system, which resides on the server 632. The automation controller 150 preferably resides on a separate and independent server or set of servers 650. The server that runs the automation controller 150 may be similar to the computer that runs the unified desktop 630 because the automation controller 150 essentially emulates the unified desktop when executing test scripts.

The automation controller 150 receives the prioritized test scripts from the prioritization and assignment manager 130, and accesses multiple virtual machines 640 to perform its tests. The virtual machines 640 may be “cloud-based” machines. Each virtual machine 640 includes a functional test automation tool, such as an HP Quick Test Pro, referred to as QTP, which receives the test script from the prioritization and assignment manager 130 and then executes the actual test script. Results from the test are reported back through the integration layer 634.

The test data supply chain 160 monitors the amount and type of test data required by each test script, and further monitors the current available volume of such data that is available. If the stock of available data runs low, the test data supply chain 160 requests additional test data. The test data supply chain 160 creates a mapping between the test script and the type or quantity of data that is required by the test script in order to execute properly and efficiently. The test data supply chain 160 facilitates the automation of demand management and the supply of required test data to the test scripts.

A database 636 includes a data catalog, which stores a list and/or definitions of various types of data that are modeled and stored corresponding to the various test scripts. This may increase productivity and efficiency because, rather than specifically designing and documenting the data input for each and every test script, the testing individual or designer can consult the data catalog, and if applicable, select a “canned” set of data inputs and/or expected outputs corresponding to the newly created test script. The database 636 may also include a warehouse, which stores instances of the data types that are available, or a stock of data.

When the test script is created using the modular script designer 120, the script creator specifies the type of data that is required for the test script, and may further specify the expected type of output data generated as a result of running the test script. For example, as shown in FIG. 5, the creator may specify a script module includes a Test Step #1 528 that requires inputting a telephone number and a Test Step #2 530 where the expected result 520 of clicking a Search Button is displaying customer details. Then, the type of test data required for testing includes telephone numbers and customer details. This essentially quantifies the input and output parameters of the test script. As different test scripts are added to the queue of test scripts to be handled by the prioritization and assignment manager 130 and executed thereafter, the test data supply chain 160 organizes the corresponding data for the test scripts in an efficient manner to optimize management of the input data required by the corresponding test script.

If during the development and creation of a test script, the test individual determines that the particular test script can utilize a particular data model stored in the data catalog, the test data supply chain 160 automatically maps the required data input from the data catalog directly into the test script to avoid manual intervention. Alternatively, the test individual may input a partial data request, and the test data supply chain 160 may determine, based on partial data request, whether a particular data model stored in the data catalog includes the required data for the test script. A partial data request may be an input from the test individual, such as a selection of one or more specific entities or attributes that may be required for the test script. In response to the partial data request, the test data supply chain 160 may find and automatically map a data type to the test script by searching the data catalog for a data type that includes the one or more specific entities or attributes entered by the test individual. Accordingly, when the test script is executed, the test data supply chain 160 automatically provides the required data at the appropriate time. Further, rules may be specified that enable basic data mining capability.

For example, if fifty specific test scripts require input data type “A” and twenty-seven specific test scripts require input data type “B,” the test data supply chain 160 may organize the required data types for each script and provide the respective input data type “A” or “B” data to the test script in a “just-in-time” manner to avoid redundancy, increase efficiency, and reduce complexity.

Additionally, such test data may change throughout the lifecycle of the testing process based on the results of a particular test script. Accordingly, the test data supply chain 160 tracks the required changes and updates the data sets required for the corresponding test scripts so that as the test scripts are being executed, up-to-date test data is available as the test scripts execute.

As described above, the test data supply chain 160 provides the appropriate data to the test script at the appropriate time. Certain test scripts may require a sequential supply of data, which may change as the test script executes. Accordingly, the test data supply chain 160 monitors the demand for such data compared to the capacity for all types of data. As the data is consumed by the test script, the levels of available data from the data catalog are monitored and updated by the test data supply chain 160.

The test data supply chain 160 may also manage the stock levels of available data types by assigning data types that are more abundantly stocked. When the test data supply chain 160 receives a partial data request, the test data supply chain 160 may determine which data types in the data catalog include the required entities or attributes. Then, the test data supply chain 160 may determine which of the data types that include the required entities or attributes has the highest level of stock available and assign, or map, that data type to the test script.

For example, data type “A” may include customer account information, such as customer identifiers, billing addresses, telephone numbers, dates of birth, and credit ratings for a number of customers. Data type “B” may also include customer account information, but only includes customer names, billing addresses and telephone numbers. If a test script only requires telephone numbers, then data types “A” and “B” are both appropriate data types. The test data supply chain 160 may determine which of the two data types to assign based on the demand and stock level of each data type.

The test data supply chain 160 communicates with the prioritization and assignment manager 130 to avoid executing test scripts that do not have the required input data available, or where stock levels of such input data are low. If additional test data is required by the test script but is currently unavailable, the test data supply chain number 160 requests the prioritization and assignment manager 130 to issue a task request to a testing individual so that the testing individual with the required skill level can prepare additional test data for the test scripts requiring such test data. Alternatively, in situations where test data preparation is fully automated, such a request will be made to the automation controller 150 rather than to the prioritization and assignment manager 130.

The test data supply chain 160 may also provide the following functionalities: forecasting demand for each data type; identifying when stock levels for a data type falls below a forecasted requirement for the data type; determining a required contingency of data based on previous releases; triggering automated data provisioning; and accepting new data items from automated provisioning processes; determining, based on the test steps and parameters, the state of a data item when the data item is returned to the warehouse.

Users of the test data supply chain 160 may include testers or test individuals and test data team members. The following table shows functionalities that the test data supply chain 160 may provide to users. Other implementations of the test data supply chain 160 may include fewer, additional or other functionalities and users.

Table of Test Data Supply Chain Functionalities

| User | Functionality |
|---|---|
| test data team | create a data model |
| member | |
| test data team | add new entities to the data model |
| member | |
| test data team | add new attributes to each entity |
| member | |
| test data team | edit the type of value that can be entered in each entity |
| member | |
| test data team | make entities mandatory/non-Mandatory |
| member | |
| test data team | make attributes mandatory/non-Mandatory |
| member | |
| test data team | deactivate/remove entities |
| member | |
| test data team | deactivate/remove attributes |
| member | |
| test data team | create data types |
| member | |
| test data team | view the requests table |
| member | |
| test data team | specify entities and attributes as being “not defined” |
| member | when creating data types |
| test data team | specify possible return types for a data item (e.g. |
| member | customer number, customer address, etc.) |
| test data team | select from options for existing data types that may |
| member | fulfill requirements for creating a new data item |
| test data team | deactivate data items |
| member | |
| test data team | track the number of data types required in current |
| member | cycle/release |
| test data team | update the requests table once data is provisioned |
| member | |
| test data team | receive an alert when data items are running low on |
| member | stock |
| test data team | receive an alert when data items are out of stock |
| member | |
| test data team | move completed requests by the data team in to the |
| member | warehouse |
| test data team | access a UI to enter the details of data types that have |
| member | been provided (incl. their return values) and then store |
| | this in the warehouse |
| test data team | link data types to automated provisioning mechanisms |
| member | |
| test data team | track the number of data types available and their |
| member | information/status |
| test data team | produce a prioritized list of data requests that need to be |
| member | fulfilled |
| tester | specify the environment that data items are required on |
| tester | create data types at script creation time |
| tester | create data types at any time, without creating a script |
| tester | select from options for existing data types that may fulfill |
| | requirements for creating a new data item |
| tester | specify specific or non-specific attributes or elements |
| tester | specify the return type required for my data item, from |
| | the available options |
| tester | link input/output variables of a script to the return |
| | variables from a data item |
| tester | select a data type required to execute a script |
| tester | create a new data type if none exists |
| tester | select a data type from a favorites list |
| tester | define what state the data is left in at execution time when |
| | a test completes prematurely |
| tester | define what state the data will be in at data type creation/ |
| | selection time once a test completes successfully |

The reporting portal 170 handles the reporting functions for the next generation testing system 100. The reporting portal 170 may be based on the Microsoft Business Intelligence system, which is a commercially available software package. The reporting portal 170 also includes an off-line data warehouse (“DW”) to avoid testing tool degradation. An off-line DW may be maintained to avoid queries directly on the external testing tool. A dimension based data model is used for simplified reporting. Further, data is pre-aggregated in a multidimensional online analytical processing (“MOLAP”) database to provide quick analysis. The reporting portal 170 further provides cube-based metrics and KPIs. Using SS Analysis Services, measures and targets may have been pre-defined, which can be included into reports. PowerPivot, a spreadsheet add-in available from Microsoft Corporation, allows data to be quickly analyzed in spreadsheet programs, such as Microsoft Excel™ for ad-hoc reports. Further, the reporting portal 170 provides integration with solutions, such as Microsoft SharePoint™. Where data from systems other than the HP Quality Center™ is required (for example, financial/production data), the solution can receive data from solutions, such as Microsoft SharePoint™. The SSIS component allows the solution to be easily extended to direct data sources where required. The reporting portal 170 provides an interface to the various modules of the next generation testing system 100 and handles all of the report generation, report format manipulation, and other reporting functions.

The defect management tool 180 permits each testing individual to quickly identify and track defects in the testing process. Various fields of the defect will be pre-populated based on the current test that is being executed. The defect management tool 180 may simplify the process for raising, tracking and updating defects. The defect management tool 180 may provide a defect watch list. Toolbar based list of defects with real-time Red, Amber or Green (RAG) status indicators may be provided. Red status indicates high risk or serious project issues, amber status indicates medium risk, and green status indicates low risk. The defect management tool 180 may allow quick access to full information of the defects to see the latest status.

The defect management tool 180 may also provide in-line defect raising with test history. While executing a test through the toolbar, screenshots and test steps may be captured. When a defect is raised, this information is pre-populated in the defect. Screenshots and other attachments can be uploaded directly. The defect management tool 180, also reduces “alt-tab” operations. By including core defect management in the toolbar, the defect management tool 180 is able to reduce the need to “alt-tab” into an external testing system, such as the HP Quality Center™. The defect management tool 180 also enables automated un-blocking of scripts to further avoid time spent in the external testing system. The defect management tool 180 further provides team based views. Managers have a ‘team view’ to enable them to see the defects currently impacting their team with the relevant size and status.

The next generation testing system and 100 may be embodied as a system cooperating with computer hardware components and/or as computer-implemented methods. The next generation testing system 100 may include a plurality of software modules or subsystems. The modules or subsystems, may be implemented in hardware, software, firmware, or any combination of hardware, software, and firmware, and may or may not reside within a single physical or logical space. For example, the modules or subsystems referred to in this document and which may or may not be shown in the drawings, may be remotely located from each other and may be coupled by a communication network.

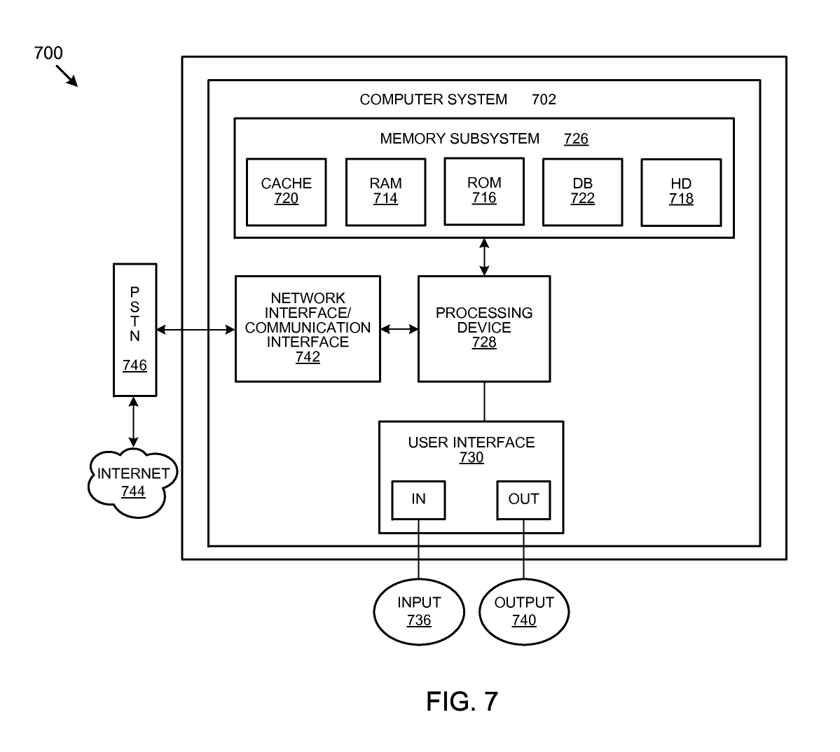

FIG. 7 is a high-level hardware block diagram of one embodiment of a computer or machine 700, such as the server 632 and 650, the PC executing the unified desktop 630, and the virtual machines 640. The next generation testing system 100 may be embodied as a system cooperating with computer hardware components and/or as computer-implemented methods. The next generation testing system 100 may include a plurality of software modules or subsystems. The modules or subsystems may be implemented in hardware, software, firmware, or any combination of hardware, software, and firmware, and may or may not reside within a single physical or logical space. For example, the modules or subsystems referred to in this document and which may or may not be shown in the drawings, may be remotely located from each other and may be coupled by a communication network.

The computer or machine 700 may be a personal computer or a server and may include various hardware components, such as RAM 714, ROM 716, hard disk storage 718, cache memory 720, database storage 722, and the like (also referred to as “memory subsystem 726”). The computer 700 may include any suitable processing device 728, such as a computer, microprocessor, RISC processor (reduced instruction set computer), CISC processor (complex instruction set computer), mainframe computer, work station, single-chip computer, distributed processor, server, controller, micro-controller, discrete logic computer, and the like, as is known in the art. For example, the processing device 728 may be an Intel Pentium® microprocessor, x86 compatible microprocessor, or equivalent device, and may be incorporated into a server, a personal computer, or any suitable computing platform.

The memory subsystem 726 may include any suitable storage components, such as RAM, EPROM (electrically programmable ROM), flash memory, dynamic memory, static memory, FIFO (first-in, first-out) memory, LIFO (last-in, first-out) memory, circular memory, semiconductor memory, bubble memory, buffer memory, disk memory, optical memory, cache memory, and the like. Any suitable form of memory may be used, whether fixed storage on a magnetic medium, storage in a semiconductor device, or remote storage accessible through a communication link. A user or system interface 730 may be coupled to the computer 700 and may include various input devices 736, such as switches selectable by the system manager and/or a keyboard. The user interface also may include suitable output devices 740, such as an LCD display, a CRT, various LED indicators, a printer, and/or a speech output device, as is known in the art.

To facilitate communication between the computer 700 and external sources, a communication interface 742 may be operatively coupled to the computer system. The communication interface 742 may be, for example, a local area network, such as an Ethernet network, intranet, Internet, or other suitable network 744. The communication interface 742 may also be connected to a public switched telephone network (PSTN) 746 or POTS (plain old telephone system), which may facilitate communication via the Internet 744. Any suitable commercially-available communication device or network may be used.

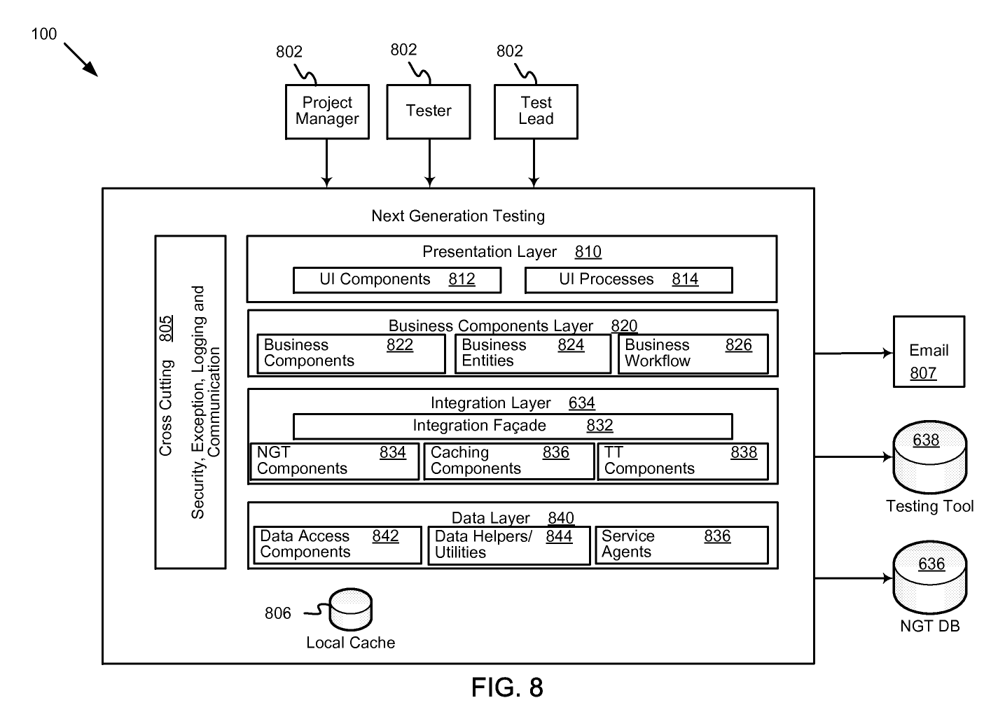

FIG. 8 shows a conceptual diagram of an embodiment of the NGT system 100. As shown in FIG. 8, the NGT system 100 may include a presentation layer 810, a business component layer 820, the integration layer 634, and a data layer 840. The presentation layer 810 includes user interface (UI) components 812 which render and format data for display to users 802, including project managers, testers, and test leads, and acquire and validate data that users 802 enter. The presentation layer 810 also includes UI process components 814 that drive the process using separate user process components to avoid hard coding the process flow and state management logic in the UI elements themselves. The business components layer 820 implements business logic and workflow. The business components layer 820 includes business components 822 which implement the business logic of the application. The business components layer 820 also includes business entities 824 and business workflow 826. Business entities are data transfer objects in the business components layer 820. These are common objects that can be used across the layers, including the presentation layer 810, to pass data around.

Integration layer 634 provides backend agnostic access to the upstream layers (business components layer 820 and presentation layer 810), and enables plug-ability via a common interface to one or more backend systems such as QC, Rational and Team Foundation Server. Integration layer 634 implements the following design pattern: an abstract base class inherits from ProvideBase (which is a class available with Microsoft's .Net framework); each concrete implementer in turn inherits from the abstract class above; Appropriated Provider (which is a class available with Microsoft's .Net framework) is loaded based on type definition in a .config file. The integration layer 634 also includes the integration facade 832. Integration facade 832 exposes a simplified interface to the business components layer 820, and reads data from a combination of data transfer objects from one or more backend repository or cache (e.g., Windows Server R2) and merges them to a common super data transfer object to return to the business components layer 820. Integration layer 634 also includes NGT components 834 which interface between the integration facade 832 and the data layer 840 and may provide mapping functionality for the integration layer 634 if required. The integration layer 634 also includes caching components 836 and testing tool components 838. Testing tool components 838 are providers servicing requests for data read/write from a Testing Tool 804.

The data layer 840 includes data access components 842 which centralize the logic necessary to access underlying NGT data store, exposing methods to allow easier and transparent access to the database. It also includes data helper/utilities 844 which are used to centralizing generic data access functionality such as managing database connections. The data layer 840 also includes service agents 836 which provide Windows Communication Foundation services proxy for talking to application server services. The data layer 840 may be an Enterprise Library Data Access Application Block or a custom designed data layer. Alternatively, object relational mapping tools, such as Entity Spaces (available from EntitySpaces, LLP), Genome (available from TechTalk, GmbH), LINQ-to-SQL (available from Microsoft Corporation), Entity Framework (also available from Microsoft Corporation), or LLBLGen Pro (available from Solutions Design), may be used to generate the data layer 840 components.

Cross cutting functions 805 in the NGT 100 may include, for example, security, exceptions handling, locking, and communication. The NGT 100 may also include a local cache 806. Outputs from the NGT 100 may include, for example, email functionality 807 or other information communication functionality. Emails may include notifications to testers regarding script rejection or approval, notifications to approvers regarding scripts that are ready for review, and notifications regarding security concerns, system exceptions, and auditing. The NGT 100 may also communicate information to testing tool 330 and an NGT database 636.

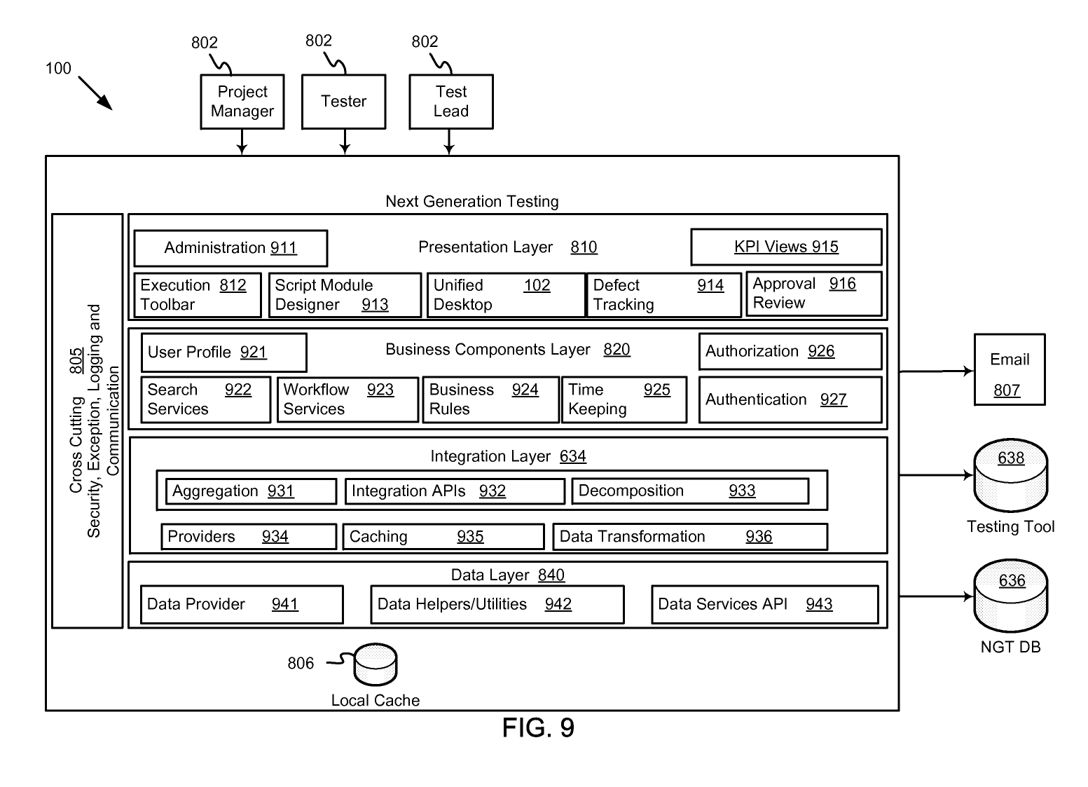

FIG. 9 shows a logical diagram of an embodiment of the NGT system 100. In the embodiment, the presentation layer 1410 may include a plurality of UI components 1412 and UI processes 1414, including an administration interface 911, an execution toolbar 912, a script module designer 913, a unified desktop 102, a defect tracking interface 914, KPI views 915, and an approval review interface 916. The business components layer 1420 may include a plurality of components, including a user profile component 921, a search services component 922, a workflow services component 923, a business rules component 924, a time keeping component 925, an authorisation component 926, and an authentication component 927. The integration layer 634 may include an integration facade 1432, which may include aggregation 931, integration APIs 932, and decomposition 933. The integration layer 634 may also include providers 934, caching 935, and data transformation 935. The data layer 1440 may provide access to a data provider 941, data helper/utilities 942, and data services API 943.

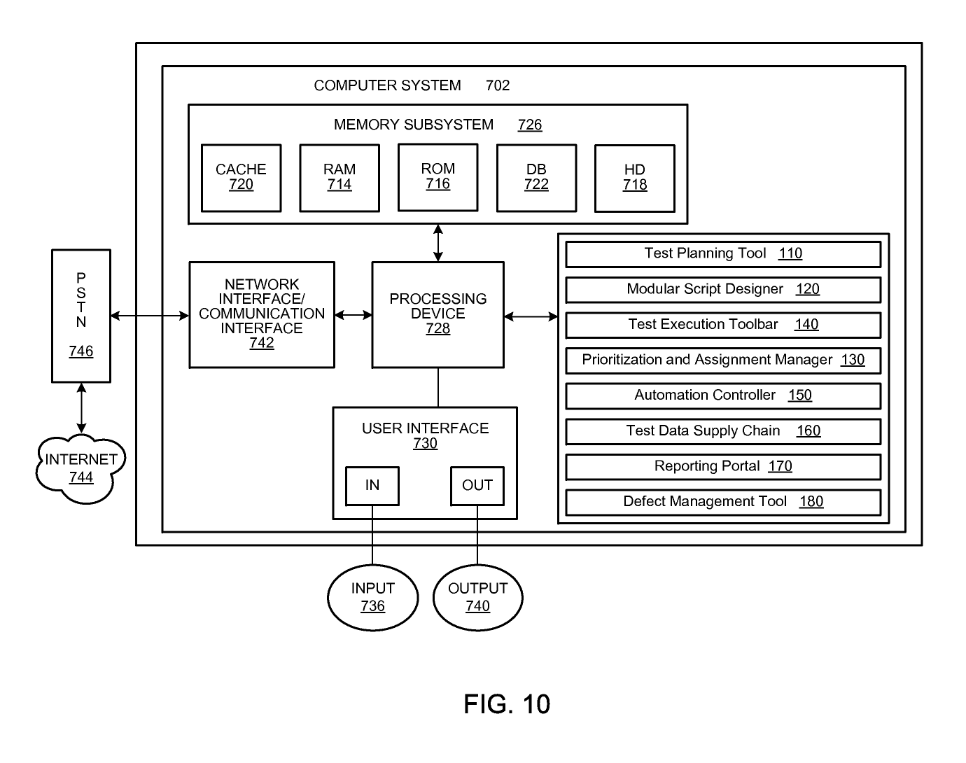

FIG. 10 is a high-level hardware block diagram of another embodiment of the NGT system. The NGT system 100 and its key components 110, 120, 130, 140, 150, 160, 170, and 180 may be embodied as a system cooperating with computer hardware components, such as a processing device 728, and/or as computer-implemented methods. The NGT system 100 may include a plurality of software components or subsystems. The components or subsystems, such as the test planning tool 110, the modular script designer 120, the prioritization and assignment manager 130, the test execution toolbar 140, the automation controller 150, the test data supply chain 160, the reporting portal 170, and/or the defect management tool 180, may be implemented in hardware, software, firmware, or any combination of hardware, software, and firmware, and may or may not reside within a single physical or logical space. For example, the modules or subsystems referred to in this document and which may or may not be shown in the drawings, may be remotely located from each other and may be coupled by a communication network.

The logic, circuitry, and processing described above may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for examples, instructions for execution by a processor, controller, or other processing device.

The medium may be implemented as any device that contains, stores, communicates, propagates, or transports executable instructions for use by or in connection with an instruction executable system, apparatus, or device. Alternatively or additionally, the logic may be implemented as analog or digital logic using hardware, such as one or more integrated circuits, or one or more processors executing instructions; or in software in an application programming interface (API) or in a Dynamic Link Library (DLL), functions available in a shared memory or defined as local or remote procedure calls; or as a combination of hardware and software.

In other implementations, the logic may be represented in a signal or a propagated-signal medium. For example, the instructions that implement the logic of any given program may take the form of an electronic, magnetic, optical, electromagnetic, infrared, or other type of signal. The systems described above may receive such a signal at a communication interface, such as an optical fiber interface, antenna, or other analog or digital signal interface, recover the instructions from the signal, store them in a machine-readable memory, and/or execute them with a processor.

The systems may include additional or different logic and may be implemented in many different ways. A processor may be implemented as a controller, microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instructions may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method of supplying test data for test scripts in an integrated testing platform, the testing platform having a prioritization and assignment manager configured to forward test scripts to a selected testing individual, the method comprising:
mapping an input data set to each test script if a corresponding input data set is available;
monitoring requests for test scripts made to the prioritization and assignment manager;
if the test script to be supplied in response to the request has a mapped input data set, retrieving the corresponding input data set from a database; and
providing the retrieved input data set to the test script prior to execution of the test script.

2. The method according to claim 1, wherein if the test script to be supplied in response to the request does not have a corresponding input data set, then requesting the prioritization and assignment manager to issue a task to generate the input data set.

3. The method according to claim 2, wherein the task to generate the input data set is forwarded to a test individual having a skill set matching a skill set corresponding a test script for which the input data set is to be generated.

4. The method according to claim 1, wherein the database includes a plurality of input data sets corresponding to a plurality of test scripts, respectively.

5. The method according to claim 1, wherein the prioritization and assignment manager sets a low priority for test scripts for which an input data set is unavailable.

6. A system for supplying test data for test scripts in an integrated testing platform, the testing platform having a prioritization and assignment manager configured to forward test scripts to a selected testing individual, the system comprising:
a computer processor coupled with a memory, a network interface, and a test data supply chain component, wherein the test data supply chain component is operable to:
retrieve from the memory a plurality of test scripts and an input data set;
map the input data set to each test script if a corresponding input data set is available from the memory;
monitor, on the computer processor, requests for test scripts made to the prioritization and assignment manager;
if the test script to be supplied in response to the request has a mapped input data set, retrieve the corresponding input data set from a database stored on the memory; and
provide, at the network interface, the retrieved input data set to the test script prior to execution of the test script by the computer processor.

7. The system according to claim 6, wherein if the test script to be supplied in response to the request does not have a corresponding input data set, then request the prioritization and assignment manager to issue a task to generate the input data set.

8. The system according to claim 7, wherein the task to generate the input data set is forwarded to a test individual having a skill set matching a skill set corresponding a test script for which the input data set is to be generated.

9. The system according to claim 6, wherein the database includes a plurality of input data sets corresponding to a plurality of test scripts, respectively.

10. The system according to claim 6, wherein the prioritization and assignment manager sets a low priority for test scripts for which an input data set is unavailable.

11. A method of supplying test data for test scripts in an integrated testing platform, the testing platform having a prioritization and assignment manager configured to forward test scripts to a selected testing individual, the method comprising:
determining a supply of an input data set, wherein the input data set includes an input data type and an input data quantity;
monitoring requests for test scripts made to the prioritization and assignment manager;
if a supplied test script is supplied in response to the requests for test scripts, determining, for the supplied test script, a required test data set, wherein the required data set includes a test data type and a test data quantity;
if the input data type matches the test data type and if the input data quantity matches the test data quantity, retrieving the input data set from a database and map the input data set to the requested test script; and
providing the retrieved input data set to the test script prior to execution of the test script.

12. The method according to claim 11, wherein if the input data type does not match the test data type or if the input data quantity does not match the test data quantity, then requesting the prioritization and assignment manager to issue a task to generate a new input data set, wherein the new input data set includes a new input data type the matches the test data type.

13. The method according to claim 12, wherein the task to generate the new input data set is forwarded to a test individual having a skill set matching a skill set corresponding the supplied test script for which the new input data set is to be generated.

14. The method according to claim 11, wherein the database includes a plurality of input data sets corresponding to a plurality of test scripts, respectively.

15. The method according to claim 11, wherein the prioritization and assignment manager sets a low priority for execution of test scripts for which an input data set is unavailable.

16. A method of supplying test data for test scripts in an integrated testing platform, the testing platform having a prioritization and assignment manager configured to forward test scripts to a selected testing individual, the method comprising:
determining a supply of an input data set, wherein the input data set includes an input data type and an input data quantity;
monitoring requests for test scripts made to the prioritization and assignment manager;
if a supplied test script is supplied in response to the requests for test scripts, determining, for the supplied test script, a required test data set, wherein the required data set includes a test data type and a test data quantity;
if the input data type matches the test data type and if the input data quantity matches the test data quantity, retrieving the input data set from a database and map the input data set to the requested test script; and
providing the retrieved input data set to the test script prior to execution of the test script.

17. The system according to claim 16, wherein if the input data type does not match the test data type or if the input data quantity does not match the test data quantity, then request the prioritization and assignment manager to issue a task to generate a new input data set, wherein the new input data set includes a new input data type the matches the test data type.

18. The system according to claim 17, wherein the task to generate the new input data set is forwarded to a test individual having a skill set matching a skill set corresponding the supplied test script for which the new input data set is to be generated.

19. The system according to claim 16, wherein the database includes a plurality of input data sets corresponding to a plurality of test scripts, respectively.

20. The system according to claim 16, wherein the prioritization and assignment manager sets a low priority for execution of test scripts for which an input data set is unavailable.
